(19) United States
(12) Patent Application Publication
(10) Pub. No.: US 2010/0136504 A1
(43) Pub. Date: Jun. 3, 2010

(54) DUAL OPTION ORTHODONTIC IMPLANT DRIVER FOR PLACING AND TIGHTENING IMPLANTS

(75) Inventor: Jefferson Sabilla, Ontario, CA (US)

Correspondence Address: WOOD, HERRON & EVANS, LLP, 2700 CAREW TOWER, 441 VINE STREET, CINCINNATI, OH, 45202, US

(73) Assignee: ORMCO CORPORATION, Orange, CA (US)

(21) Appl. No.: 12/444,074

(22) PCT Filed: Oct. 10, 2007
(86) PCT No.: PCT/US07/80887

§ 371 Date: Jan. 11, 2010

Related U.S. Application Data
(60) Provisional application No. 60/850,624, filed on Oct. 10, 2006.

(51) Int. Cl. A61C 3/02; A61C 8/00

(52) U.S. Cl. 433/141; 433/174

(57) ABSTRACT

The present invention embodies an apparatus and method to drive an orthodontic implant while minimizing the risk of damaging the implant. More specifically, a dual option driver (10) is adapted to drive an orthodontic implant (42) using both the base (38) and the top (36) of the head portion of the implant. When engaged with the base (38) of the implant head (36), the driver (10) has a friction fit with the implant due to a retaining clip (48) which mates with the top of the implant head (36). The primary force for driving is transferred to the screw through the base. This protects the neck (40) of the implant head from high torque forces. In addition, the retaining clip (48) allows a clinician to pick up the implant (42) using only one hand so that the clinician never has to touch the implant. Once installed, the driver (10) can adjust the implant (42) by engaging the top of its head portion (36).

This application claims the benefit of U.S. Provisional Patent Application Ser. No. 60/850,624, filed Oct. 10, 2006 and entitled “Orthodontic Devices, Implants and Related Apparatus,” the disclosure of which is expressly incorporated by reference herein in its entirety.

### FIELD OF THE INVENTION

This invention relates in general to the dental field of orthodontics and more particularly to an apparatus and method used in an orthodontic implant procedure.

### BACKGROUND OF THE INVENTION

Dental implants are used in the dental profession in general, and more particularly in the branches or specialties of orthodontics, oral surgery, periodontics, and restorative dentistry. More specifically, an orthodontist may use an orthodontic implant to provide a firm anchorage from which to attach wires, springs, and like peripheral devices for use in aligning or straightening misaligned or irregular teeth. The use of such an implant allows for a skeletal anchorage which is more predictable and stable than using headgear or elastics which require patient compliance. A skeletal anchorage also eliminates the need for using other teeth as an anchor. This in turn, eliminates the unwanted movement of these anchor teeth, for when one tooth is used as an anchor to move another, the anchor tooth will also move, even if only to a lesser degree, while the irregular or misaligned tooth moves. In short, orthodontic implants can be advantageously used in orthodontic treatment to control tooth movement.

Most orthodontic implants currently used have of a body with a working thread portion and a head portion. The head portion consists of a base, a narrower neck, and a top. The narrower neck provides an area between the base and top to trap or locate a matching eyelet which is used primarily for attaching peripheral devices such as springs, wires, etc. which in turn are attached to other orthodontic devices such as brackets. Secondarily, the head portion of the orthodontic implant acts as a platform for engaging with or an interface for driving tools. Tools and drivers mate with the base or top of the head to apply torque and drive the implant into the bone.

However, there are certain inherent risks or drawbacks to installing implant screws with a conventional driver. For example, if a driver engages the top of the head portion of the implant, the torque needed to screw the implant into a patient's bone may be such that the neck is bent or broken. Additionally, a driver designed to mate with the base of the head portion of the implant may be ineffective to use once peripheral devices are attached to the implant. Finally, mating a driver with a small implant screw generally requires a clinician to use two hands and touch the implant, thus making the procedure more cumbersome and increasing the risk of contamination to the threaded portion of the implant and infection to the patient.

Hence, there is a need for a method and apparatus to drive and twist an orthodontic implant device without risk of breaking the implant or contaminating the implant. There is also a need for a clinician to be able to use the same driver to single-handedly turn an implant regardless of whether the implant has attachments.

### OBJECTS OF THE INVENTION

It is an object of the invention to provide an apparatus and method to drive and twist an orthodontic implant device while minimizing the risk of damaging the implant. It is also an object the invention to minimize the risk of contaminating the implant prior to its insertion. It is also an object to allow a clinician to use the same driver to turn the implant regardless of whether it has peripherals attached to the implant. It is also an object of the invention to allow a clinician to use a driver to insert and turn an implant with only one hand.

### SUMMARY OF THE INVENTION

The present invention is a dual option driver that is adapted to drive an orthodontic implant using both the base portion and the top of the head portion of the implant. Orthodontic implants which are suitable for use with the driver of the present invention are disclosed in co-pending PCT International application No. ______, filed on Oct. 10, 2007, entitled “Orthodontic Implants,” which is expressly incorporated by reference herein in its entirety. When engaged with the base of the implant head, the driver has a friction fit with the implant due to a retaining clip which mates with the top of the implant head. The clip can also take the form of an elastomeric o-ring or be sized slightly smaller than the implant head itself to provide the interference fit. However, the primary force for driving is transferred to the implant screw through the base of the head, which is the strongest part of the head. This protects the neck of the implant head from high forces due to the applied torque. In addition, the friction fit interface between the driver and the implant allows it to engage a tool using only one hand. A clinician can pick up the implant using the driver directly from the packaging without touching or contaminating the threads of the implant. The dual option driver also provides stability while a clinician is inserting an implant by keeping the implant from wobbling back and forth while driving the screw into bone.

Additionally, when the dual option driver is engaged with the top of the implant head, the dual option driver does not have a friction fit with the implant. The purpose of the top of the head is to allow the doctor to tighten or loosen the screw when it is already in place. The dual option driver can access the top of the implant even if attachments are in place. Also, the lack of a friction fit prevents the practitioner from using the top of the head to initially drive the implant. This protects it from failing at the neck during insertion.

The above and other objects and advantages of the present invention shall be made apparent from the accompanying drawings and the brief description thereof.

### BRIEF DESCRIPTION OF THE DRAWINGS

The accompanying drawings, which are incorporated in and constitute a part of this specification, illustrate at least one embodiment of the invention and, together with a general description of the invention given above and the detailed description of the embodiment(s) given below, serve to explain the principles of the invention.

FIG. 1 is a disassembled perspective view of one embodiment of the driver of the present invention.

FIG. 2A is an assembled perspective view of the driver of FIG. 1.

FIG. 2B is a perspective view of the implant partially showing the implant in place.

FIG. 3A is an axial cross-sectional view of the driver and implant shown in FIG. 2A prior to the implant being fully driven into a bone structure.

FIG. 3B is an axial cross-sectional view of the driver and implant shown in FIG. 3A after the implant is fully driven into a bone structure.

### DETAILED DESCRIPTION OF THE INVENTION

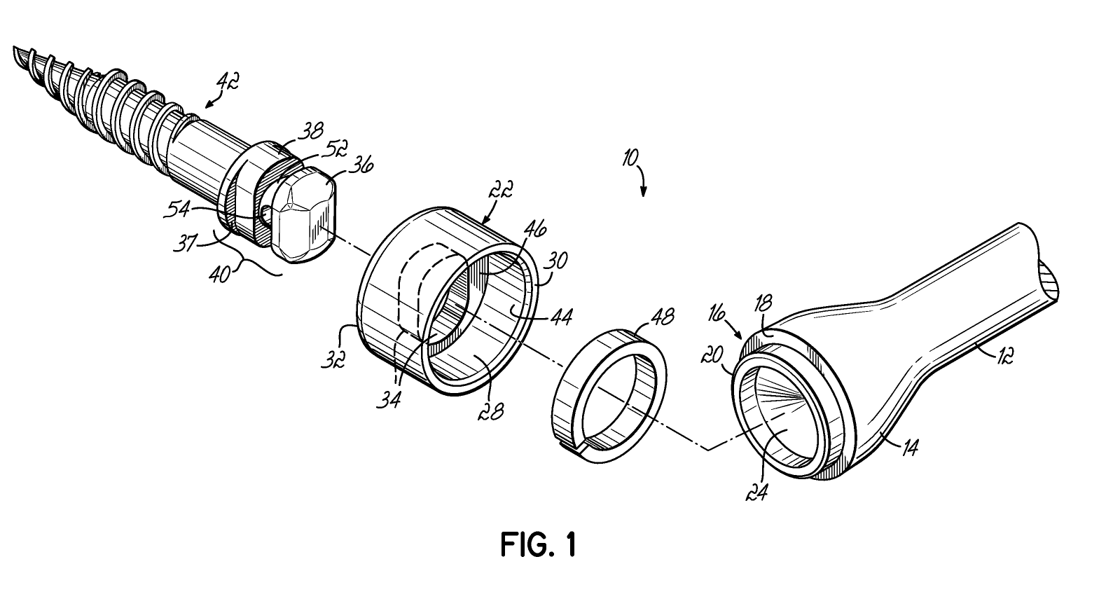

Referring to the Figures, and to FIG. 1 in particular, a disassembled perspective view of one embodiment of the present invention is shown. As illustrated, the driver 10 has a generally elongated cylindrical body or handle 12 that is flared at one end 14. The flared end 14 has a slow speed latch 16 comprised of a ledge 18 with a raised annular ring 20. The slow speed latch 16 allows the driver 10 to frictionally mate with a driver tip 22. Alternatively, the driver 10 and the driver tip 22 could be attached to one another via any suitable bonding method known to those skilled in the art.

The annular ring 20 further defines a generally cylindrical aperture or cavity 24 in the driver 10. As shown, the aperture 24 is conically shaped at the end 26 distally positioned from the ring 20. In alternative embodiments, the interior cavity 24 in the driver 10 could be formed in other shapes without detracting from the principles of the present invention.

The driver tip 22 is generally cylindrical in shape with a hollow interior compartment 28. As mentioned, one end 30 of the driver tip 22 is adapted to mate with the driver 10 via the slow speed latch 16. The end 32 of the driver tip 22 positioned distally from the driver 10 has an aperture or opening 34 which is sized and configured to mate with the top 36 or the base 38 of the head portion 40 of an implant 42. For example, end 32 may contact ledge 37 to form a positive stop. The inside wall 44 of the driver tip 22 has a ledge 46 which is used to retain a retaining clip 48. As shown, the retaining clip or spring clip 48 is sandwiched between the ledge 46 and the annular ring 20 of the driver 10. The retaining clip 48 may be a metal clip or in the form of an elastomeric o-ring or in some other form, the circumference of which is generally slightly smaller than the circumference of the top 36 of the head 40 of the implant 42.

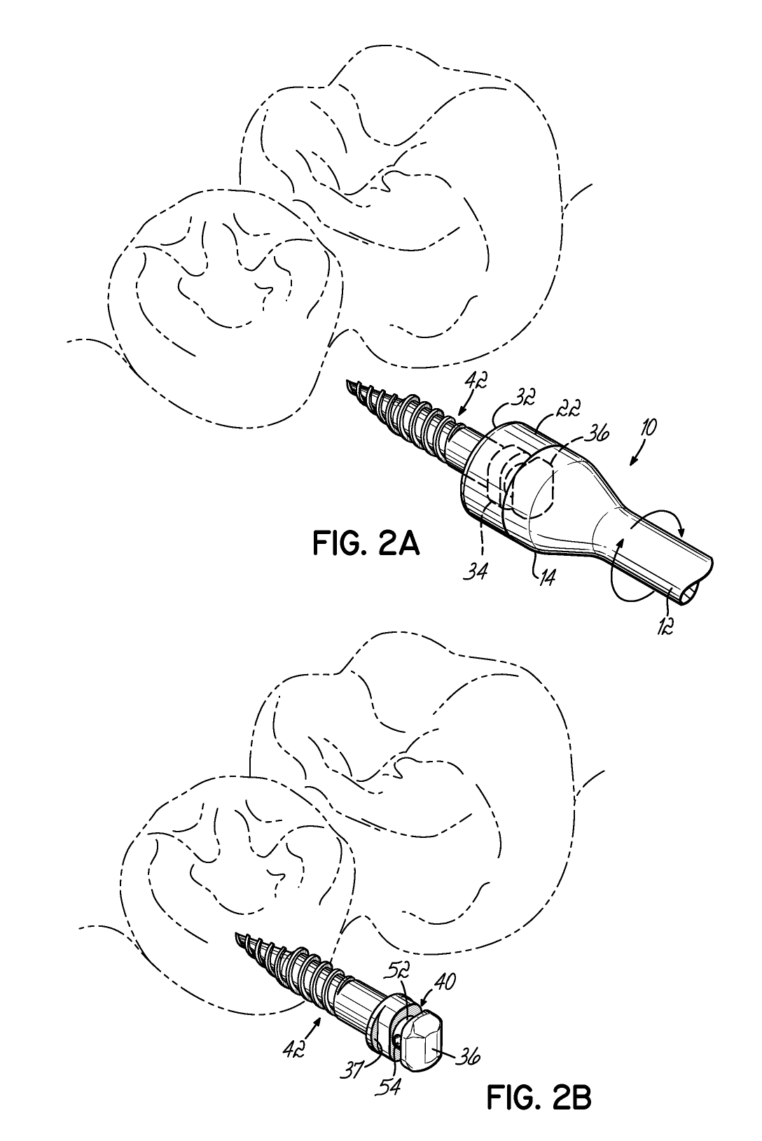

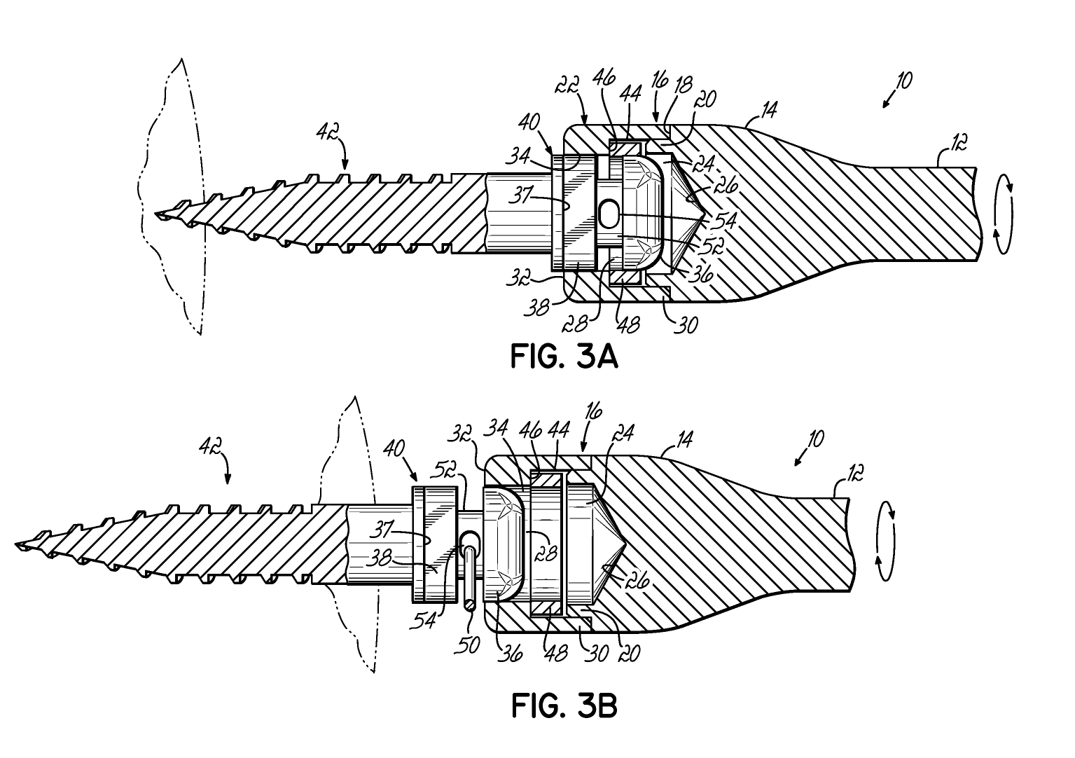

In operation, a clinician can use the driver 10 to directly pick up an implant 42 from a package or tray. As shown in FIG. 2A, the driver 10 can securely hold the implant 42 prior to its insertion in a patient. More specifically, as illustrated in FIG. 3A, when the implant 42 is initially picked up for installation and while it is being driven into a patient, the top 36 of the head 40 of the implant 42 is secured within the driver 10 and driver tip 22 assembly by the retaining clip 48 so that the implant 42 will not fall out. In other words, the retaining clip 48 allows a clinician to select an implant 42, securely pick it up with a driver 10, and insert it into a patient without ever touching the implant 42 and without having to using two hands to hold both the implant 42 and the driver 10. This enables the clinician to more advantageously perform the implant procedure as one of the clinician's hands are free to perform other tasks. Prior to implanting the implant 42, the clinician may drill a small pilot hole or starter hold using a device of the type disclosed in co-pending PCT International application No. ______, filed on Oct. 10, 2007, entitled “Drill for Orthodontic Implants,” which is expressly incorporated by reference herein in its entirety.

As shown in FIG. 3A, when the top 36 of the head 40 is inserted into the driver 10 so that it is retained by the retaining clip 48, the base 38 of the head 40 is engages the opening 34 of the driver tip 22. This is the point where the torque that is applied to the driver body 12 is transferred to the implant 42. Hence, while the retaining clip 48 keeps the implant 42 from falling out of the driver 10, the primary force that is applied to drive the implant 42 into a patient's bone is transferred to the implant 42 at the point where the opening 34 engages base 38 of the head portion 40 of the implant 42. This allows the implant 42 to be screwed into a patient's bone without snapping, bending, or otherwise damaging the implant 42. Additionally, because the retaining clip 48 will only secure the implant 42 if it is properly and fully inserted into the driver 10, it prevents potential damage to the implant 42 from, for example, attempting the drive the implant 42 into a patient's bone using only the top 36 of the head 40 of the implant 42. In other words, a clinician would not be able to pick up and hold an implant 42 without inserting the implant 42 through the opening 34 in the driver tip 22 and into the hollow interior section 28 of the driver tip 22. If the implant 42 is not inserted all the way into the driver 10, the implant 42 would simply fall out.

Once the implant 42 is inserted into a patient's skeletal structure, as illustrated in FIG. 3B, the dual option driver 10 may then be used by a clinician to adjust the implant 42. Since less torque is typically needed at this stage of the proceeding to unscrew or otherwise adjust the implant 42, the driver 10 may be used to grip the top 36 of the head 40 of the implant 42. This is advantageous as a clinician is not required to disassemble or otherwise disconnect any peripheral devices 50, such as springs or wires that might be attached to the neck 52 of the head 40 of the implant 40 via an eyelet 54. Additionally, the clinician can use the same tool that he used to install the implant 42, thus saving equipment costs by reducing the number of tools needed to perform the implant procedure.

While the present invention has been illustrated by description of one or more embodiments and while these embodiments have been described in considerable detail, it is not the intention of the applicant to restrict or in any way limit the scope of the claims to such detail. Additional advantages and modifications will readily appear to those skilled in the art. The invention in its broader aspect is, therefore, not limited to the specific details, representative system, apparatus, and method, and illustrative example shown and described. Accordingly, departures may be made from such details without departing from the spirit or scope of the applicant's general inventive concept.

What is claimed is:

1. An orthodontic implant driver device comprising:
a driver body;
a driver tip attached to the driver body, wherein the driver tip has a non-circular opening at an end distally positioned from the driver body;
wherein the non-circular opening is adapted to engage a non-circular base of a head portion of an orthodontic implant device.

2. The orthodontic implant driver of claim I wherein the driver body is generally cylindrical.

3. The orthodontic implant driver of claim 1 wherein the driver body has a flared first end adapted to connect to the driver tip.

4. The orthodontic implant driver of claim 1 wherein the driver body has a slow speed latch which is adapted to frictionally attach the driver tip to the driver body.

5. The orthodontic implant driver of claim 1 wherein the outside of the driver tip is generally cylindrical.

6. The orthodontic implant driver of claim 1 further comprising an internal element adapted to frictionally secure the orthodontic implant head within the driver.

7. The orthodontic implant driver device of claim 6 wherein the internal element is a spring retaining clip.

8. The orthodontic implant device of claim 6 wherein the internal element is an elastomeric O-ring.

9. The orthodontic implant driver of claim 6 wherein the internal element has a circumference and wherein the circumference of the internal element is less than the circumference of the top of head portion of the implant.

10. The orthodontic implant device of claim 6 wherein the internal element is sandwiched between the driver body and the driver tip.

11. The orthodontic implant device of claim 6 wherein the driver tip has a ledge adapted to secure the internal element between the driver tip and the driver body.

12. An orthodontic implant driver device comprising:
an elongated generally cylindrical driver handle, the handle having a flared end, the flared end having a slow speed latch;
a generally cylindrical driver tip frictionally attached to the slow speed latch of the driver body, the driver tip having a non-circular opening at an end distally positioned from the driver body, the opening sized to engage a non- circular head portion of an orthodontic implant; and
a retaining clip sandwiched between the flared end of the driver handle and the driver tip, the clip adapted to secure at least a portion of the head portion of the orthodontic implant when the opening in the driver tip at the end distally position from the driver body engages another portion of the head portion of the orthodontic implant.

13. The orthodontic implant driver device of claim 12 wherein the retaining clip is a spring.

14. The orthodontic implant driver device of claim 12 wherein the retaining clip has a circumference and wherein the circumference of the retaining clip is less than the circumference of the head portion of the orthodontic implant.
